(19) United States
(12) Patent Application Publication
(10) Pub. No.: US 2006/0259202 A1
(43) Pub. Date: Nov. 16, 2006

(54) SIGNALING SYSTEM

(76) Inventor: Himangshu Rai Vaish, New Delhi (IN)

Correspondence Address: Global IP Services, PLLC, 198 F, 27th Cross, 3rd Block Jayanagar, Bangalore, 560011, IN

(21) Appl. No.: 11/459,343

(22) Filed: Jul. 22, 2006

(30) Foreign Application Priority Data
Jan. 24, 2005 (WO) PCT/IN05/00029

(51) Int. Cl. G05D 11/00

(52) U.S. Cl. 700/295

(57) ABSTRACT

A signaling system is presented. The signaling system comprises a power supply line coupled to an aspect through a current regulator. The aspect has a plurality of light sources. The current regulator is configured for maintaining substantially unity power factor and for maintaining substantially constant current through the supply line during normal operation of the system. The regulator is further configured for detecting a complete/partial failure of the aspect and communicating an indication indicative of the failure over the supply line by maintaining a significantly different current level through the supply line as against the normal constant current level. A distantly located alarming system is connected to detect partial/full failure of aspect and current regulator by variation in the current flowing through the supply line as against the constant current.

### FIELD OF THE INVENTION

The present invention relates to a signaling system, and particularly to a railway signaling system.

### BACKGROUND

Movement of trains is controlled by many factors such as, track availability, scheduled arrival and/or departure time. Railway administration processes various inputs and finally conveys its decision to the train driver through Red, Yellow, Green and some times white lights.

Modern signaling systems use Light Emitting Diodes (LED). However existing LED based systems have certain limitations with respect to the heating of power supply, alarming systems and illumination of the LEDs, failure and reliability.

Existing LED based signaling are normally using a plurality of serially connected LEDs, with linear power supplies and resistive loads for activating Electric Current Relay (ECR) also known as Lamp Proving Relay. In this type of system when one or more LEDs fail the detection of failure is not foolproof because of the piece-to-piece variations in electrical characteristics of the ECR, which is connected in series, and designed for operation considering a resistive load. Poor power factor of existing systems results in not only a power inefficient system but also affects the working of the ECR

Further LED based systems require regulated voltage or current. Obtaining regulated voltages, using linear power supplies, require large heat sinks which makes the entire system heavy and prone to failure due the heating effects.

A signaling system is disclosed in U.S. Pat. No. 6,570,505, however this system requires a separate circuit for detecting failure and an independent line for communicating a failure indication.

Therefore, it was observed that there is a need of a system that does not have above drawbacks and is more efficient, lightweight, reliable, free of heating effects, free of repetitive maintenances, has multiple safety measures and higher, uniform illumination.

### OBJECT AND SUMMARY OF THE INVENTION

Therefore, it is desirable to have a signaling system that does not have above and other limitations. It is further advantageous to have a signaling system that provides a current regulator configured for maintaining a substantially unity power factor while regulating current and has multiple redundant power supplies as additional safety measure.

To this end, the invention provides a signaling system comprising, a power supply line coupled to an aspect through a current regulator, said aspect having a plurality of light sources, said current regulator, is configured for maintaining substantially unity power factor and for maintaining substantially constant current level through the supply line during normal operation of the system, said regulator is further configured for detecting a complete/partial failure of the aspect and communicating an indication indicative of the failure over the supply line by significantly varying current level through the supply line as against the normal constant current level.

According to this aspect of the invention a signaling system is provided that allows a multi-directional communication over the supply line. The current regulator of the system regulates and maintains a substantially constant current flow through the supply line for entire range of voltage observed at the supply line. Also the regulator is configured for maintaining the power factor substantially close to unity that is the phase difference between current and voltage at the supply line is zero or close to zero at zero crossing point of the voltage and current waveform. This reduces the power consumption, reduces the stress on power generating stations and permits an alarming system to monitor the electric current flowing in the supply line and react to changes in the current. The alarming system may be placed at a distant location. The distant location may be at any distance—typically it is between 100 m to 3 km from where the current regulator and the aspect are located. The current regulator is further provided with circuitry for detecting a complete/partial failure of the aspect. This may be achieved by a direct or an indirect feedback circuitry that may be supplied with the aspect.

Once the failure is detected by the circuitry, the signaling system communicates an indication indicative of the failure over the supply line. Communication of the indication is achieved by significantly varying the current in the supply line. Since current through the supply line should remain substantially constant during a normal operation of the system, a signification variation in the current represents a partial/complete failure of the aspect and/or current regulator. The value of the current through the supply line may be significantly decreased as compared to the value at which the current is maintained before detecting the failure. Further maintaining power factor close to unity, with the peak of the voltage and the current occurring at substantially the same time, ensures that the system uses the power efficiently and the ECRs which are designed keeping resistive load in mind have a more consistent performance.

The current through the supply line may be varied by an order by 20-80% as compared to the value of current maintained at a substantially constant level. The order of the variation is, however, not a limitation to the invention, however varying the current value in above range is sufficient for communicating different types of fault conditions.

The regulator comprises a noise sensing circuit for sensing and rejecting noise. The regulator includes a plurality of switch mode power supplies (SMPS) and/or one or more dummy load/s. The regulator further comprises a controller for controlling the current through the supply line by switching on/off the SMPS or the dummy load/s or any combination thereof and for maintaining a power factor substantially unity. The dummy loads may be SMPSs and/or resistors and/or capacitors and/or inductors and/or any combination thereof. The regulator may be provided with a redundant SMPS for ensuring an uninterrupted functioning of the system in case of failure of one or more SMPS.

This aspect of the regulator provides arrangement for sensing noise that may be received by the supply line. The noise sensing circuit may be realized using an SMPS or any other circuitry for identifying noise and rejecting the same. The regulator is further provided with a plurality of SMPS. These SMPS may be used for plurality of purposes for example; the SMPS may be used for realizing a DC to DC converter, and/or AC to DC converter, and/or realizing dummy load and/or the redundant SMPS may be provided for ensure an uninterrupted functioning of the system.

The regulator further comprises an AC to DC converter providing its output to the DC to DC converter for supplying a controlled voltage to the aspect.

According to this aspect of the system, the supply line may provide an AC input to the regulator, wherein the regulator on receipt of the AC input converts it into a DC signal using AC to DC converter. The AC to DC converter may be realized using SMPS. The DC output of the AC to DC converter may be then regulated using a DC to DC converter for supplying it to the aspect. The DC to DC converter may be realized using SMPS. DC to DC converter supplies a substantially constant voltage to the aspect. Providing a substantially constant voltage to the aspect provides a uniform illumination of aspect. A secondary optical arrangement around LEDs may further increase the intensity of illumination. The AC to DC converter, with flyback topology in buck mode, includes an Intelligent Switching Device (ISD), which drives the dummy load and the DC to DC converter in a manner that it dynamically corrects the power factor of the regulator and other loads as seen by the supply line and dynamically regulates the current flowing in the supply line by varying the output DC voltage, by sensing the current in the supply line. The current may be sensed using a current transformer or other current sensing means. According to the sensed current in the supply line a feedback may be provided to the ISD using suitable control circuitry.

The system further comprises alarming system coupled to the supply line for setting-off an alarm on receipt of an indication indicative of the failure. The alarming system may be connected to a data logger for registering functional status of components of the alarming system and the functional status of the signaling system.

The alarming system may comprise; one or more switch mode power supplies (SMPS). The SMPS may be power factor corrected, that is, the power factor is maintained close to unity. The SMPS may be connected in parallel. Each SMPS may have a test circuitry for testing its own functional status and accordingly raise alarm in case of malfunctioning of any of the power supplies. The alarming system further comprises a current sensor for sensing the current in the supply line and a comparison mechanism for comparing the variation in current in the supply line and accordingly initiating one or more alarms. The comparison mechanism may be further provided with a test circuit for testing the functional status of the comparison mechanism and raising alarm in case of any mal functioning. A data logger may be provided with the alarming system for registering functional status of power supplies, comparison mechanism, self test circuitry of the alarming system, and functional status as identified by the current sensor of the aspect and/or the power supplies of the signaling apparatus. The data logger may be connected to a central processing unit for keeping record for failure and for recording other details for example time for maintenance of the system etc. The data logger may be a microcontroller; microcontroller may be coupled to the central processing unit using modem. The microcontroller may comprise a processing circuitry, memory and input-output unit.

The signaling system comprises an ECR connected to the current regulator to sense the failure and accordingly set-off alarm/s.

Above and other aspects of the invention together with one another or individually or in combination of further aspects, achieve reducing of the power supply heating hazards and weight, providing an increased life and reliability of the signaling apparatus.

### BRIEF DESCRIPTION OF DRAWINGS

Above and other aspects of the invention as well as the embodiments thereof will now be elucidated in more detail with reference to the drawings, therein:

FIG. 1 shows a signaling system according to the present invention;

FIG. 2 shows a current regulator according to the present invention;

FIG. 3 shows another embodiment of a current regulator connected to the aspect;

FIG. 4 shows alarming system according to the present invention, and;

FIG. 5 shows another embodiment of an alarming system according to the present invention.

### DETAILED DESCRIPTION OF DRAWINGS

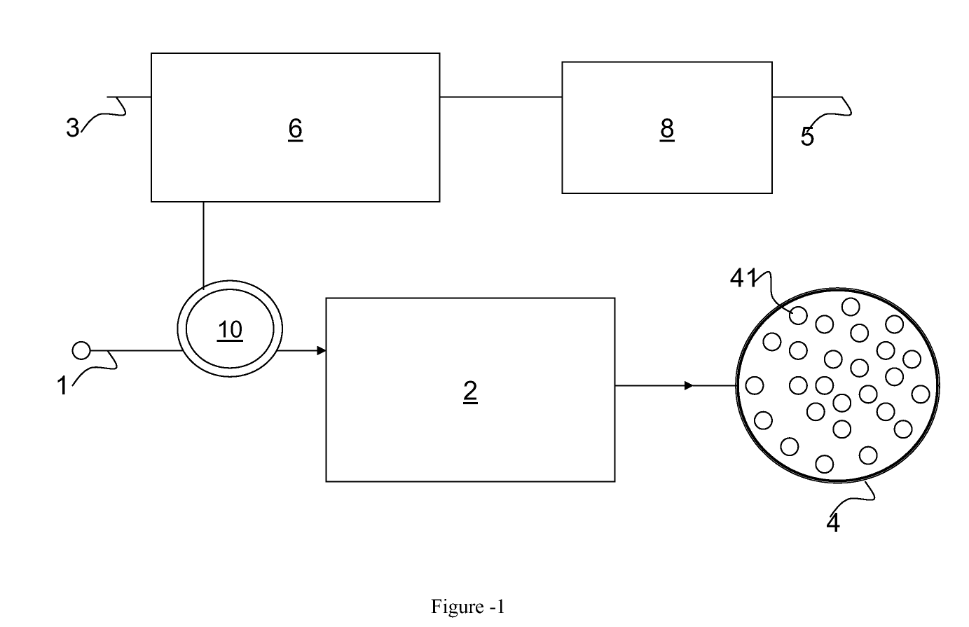

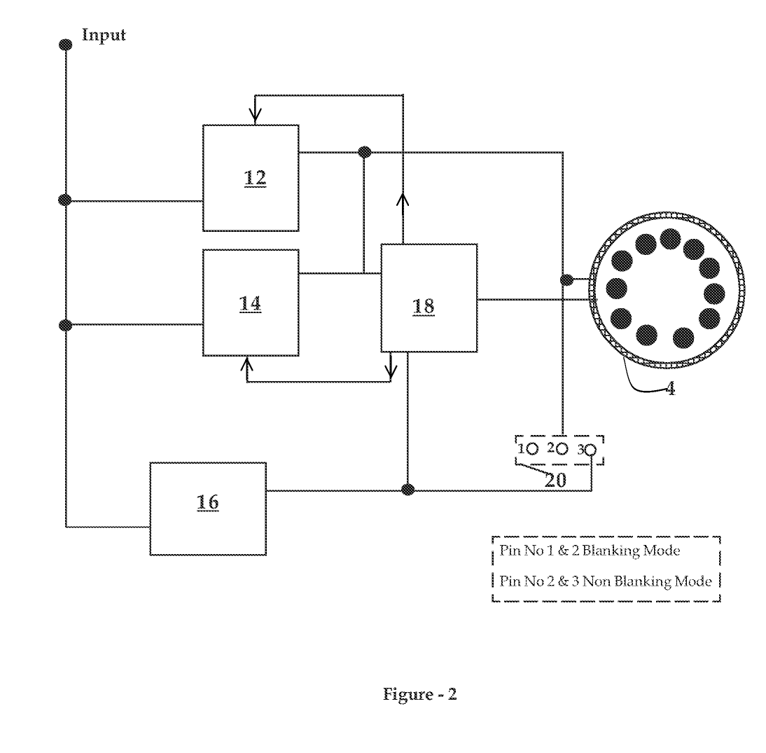

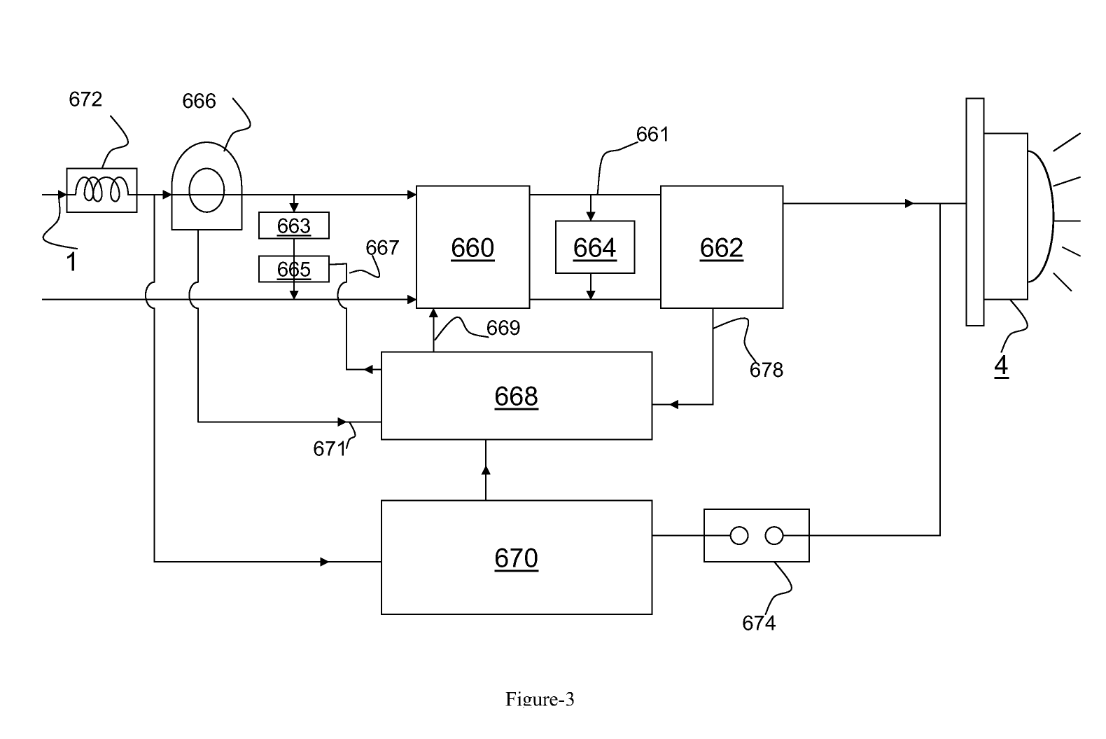

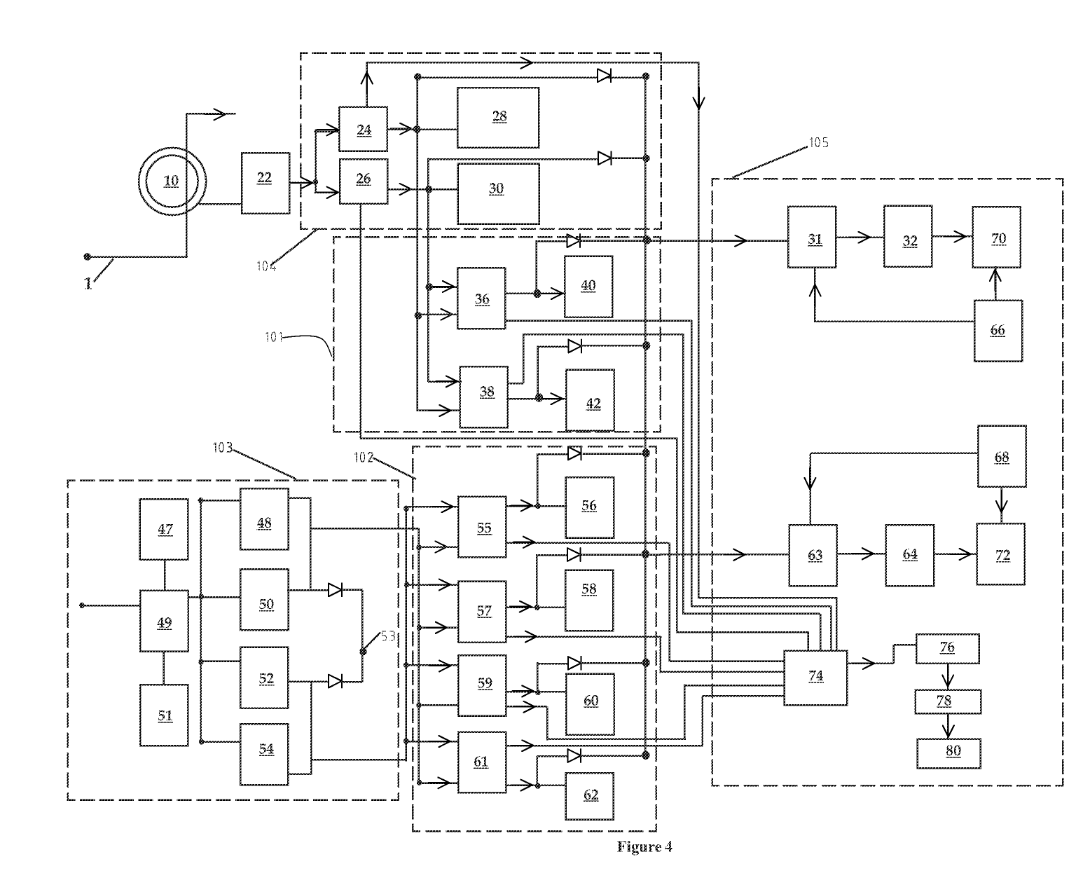

In FIG. 1, a signaling system is shown that comprises a power supply line 1 coupled to an aspect 4 through a current regulator 2. The aspect 4 comprises a plurality of LEDs 41. The LEDs 41 may be connected in parallel and/or in series or any combination thereof. The current regulator 2 provides a DC voltage to the aspect 4. The current regulator 2 regulates the current through the supply line and maintains it at a substantially constant value irrespective of the variation of the input voltage. The current regulator 2 also maintains the power factor substantially close to unity. More details in different embodiments of the current regulator are described in FIG. 2 and FIG. 3. Further the aspect 4, is coupled to an alarming system 6 through a current sensing coil 10. The sensing coil 10 is placed around the supply line 1 for sensing the current through the supply line 1. The sensing coil 10 is connected to alarming system 6. The coil 10 communicates an indication representative of the variation in current flowing through the supply line 1, which indicates functional status of the current regulator 2 and/or the aspect 4. According to the functional status of the current regulator 2 and/or the aspect 4 an alarm is raised. The alarming system 6 also checks its own functional status and sets off alarms in case of any malfunctioning. The system may be provided with one or more distantly located alarming system 8 which may be connected for simultaneously raising alarms at different locations when a failure is detected by the alarming system 6. Once any failure is detected, the alarming systems 6 and 8 provide audio and/or visual or any other type of the alarm/s to indicate the fault or failure. Further the failure may be communicated to a central computer through a data logger and modem. According to one aspect, a single alarming system 6 can monitor the performance of a number of current regulators 2 and aspects 4. 3 and 5 are the independent power supplies for the alarming units 6 and 8. More details of alarming system 6 are shown in FIG. 4.

According to a further embodiment of the invention, an ECR (not shown) may be connected at the input line of the current regulator 2 as a conventional method of protection for any failure, however the present invention without an ECR can function with equal reliability and is capable of carrying out all the functions of the ECR in conventional signaling system.

The operation of the circuit can be understood as follows. Once the decision is taken to light up a particular signal color (aspect 4), which may be over 3 k.m. away from a railway station, a voltage between 110V±25% is applied to the supply line 1 that connects the aspect 4 through the current regulator 2. The current regulator 2 not only converts the AC or DC input voltage to a DC voltage suitable for LEDs but it also controls the current through the supply line 1 and maintains the current through the supply line 1 at a substantially constant level. Further it also controls the power factor, to maintain its value close to unity. Further while maintaining the unity power factor, the regulator 2 also ensures that the peak of the voltage and the current occur at substantially the same time. This feature may be achieved by providing capacitive or inductive or resistive loads or any combination thereof for adjusting the occurrence of the peak of the current and voltage waveforms. The converted voltage by the current regulator 2 is fed to the aspect 4 to light it up. The sensing coil 10 is used to sense the current flowing through the supply line 1 and it communicates an indication representative of the variation in current flowing through the supply line 1, which indicates functional status of the regulator 2 or aspect 4 to the alarming system 6. The alarming system raises an alarm if the indication corresponds to a complete/partial failure of one or both of the regulator 2 and aspect 4. The alarming system may also raise an alarm if it observes its own failure. The alarming system may raise an audio visual or any other type of alarm. The coil 10 of the alarming system senses the variation in the current flowing through the supply line 1 which corresponds to a partial/complete failure of the aspect 4 or the current regulator 2. A comparative circuitry is provided within the alarming system that tests its internal function and reports its own failure and conveys the failure message to a station master and other concerned persons through an audio and visual alarm or any other suitable type of alarm. Further, the alarming system may provide information regarding functional status of each unit in the circuit to a data logger and/or to a regional CPU or any combination thereof for early preventive action or for statistical record. Thus this system provides warning messages to the concerned persons, of any failure in the current regulator/aspect using the supply line 1 and also provides a warning of the alarming system failure so that timely preventive maintenance can be carried out.

In FIG. 2 a more detailed block diagram of the current regulator 2 including the aspect 4 is shown which includes two or more Switch Mode Power Supplies (SMPS) 12, 14 used to realize converters. The converters are AC to DC converter and/or DC to DC converter. The SMPS are connected in parallel redundant mode such that on failure of any one of the SMPS, the remaining SMPSs will power the aspect 4 so that the aspect continues to lit even in case of failure of one or more SMPS. The controller 18 monitors the functioning of the SMPS in the current regulator 2 and the LEDs in the aspect 4. The controller 18 is powered by one or more SMPS (not shown). A noise that may be received by the supply line 1 is sensed by 16. The noise sensor 16 may be realized using SMPS. An inbuilt delay in the functioning of the controller allows the transient conditions to settle down and ensures that there is no false alarm. In case of failure of a certain number of LEDs of the aspect 4, the controller 18 switches off a redundant SMPS, say 12. By this way input current flowing through the supply line to the current regulator is reduced. If an SMPS fails, the input current is also reduced. In either case the sensor (10, of FIG. 1) senses variation in current drawn by the current regulator 2 and sends a warning message through alarming system 6 and 8 for timely preventive maintenance. If more LEDs in aspect 4 fail, the controller 18 senses the further reduction in current and switches off the SMPS say 14, thereby deactivating the ECR (not shown). In signaling systems, where there is no ECR, the actions of ECR can also be performed by alarming system 6. The aspect 4 can be connected to the current regulator 2 in blanking mode or non-blanking mode through jumpers 20. In the blanking mode aspect 4 goes off when a complete failure is observed whereas in the non-blanking mode the aspect 4 remains lit and is powered by the SMPS supplied for powering controller.

FIG. 3 shows another embodiment of the current regulator (2, of FIG. 1). The current regulator has an AC to DC converter 660 that receives power from the supply line 1 and provides a DC output while maintaining the power factor close to unity. The output of the converter 660 is supplied to a DC to DC converter 662 that converts the supply line voltage to a DC voltage that is in an acceptable range of the aspect 4 (same as 4, of FIG. 1). The AC to DC converter 662 function in flyback topology in buck mode. The converters 660 and 662 are realized using SMPS. The converter 660 includes an intelligent switching device (ISD), which drives the secondary dummy load 664 and DC to DC converter 662 in a manner so as to dynamically correct the power factor of the regulator and other loads as seen by the supply line. Further the converter 660 simultaneously dynamically regulates the current flowing through the supply line 1 by varying the output DC voltage 661 of the converter 660, with the supply line 1 voltage by sensing the current in the supply line 1 with the help of the current transformer 666. 666 provides a voltage 671 proportional to the current in the supply line 1 to the controller 668. The controller generates a feedback 669 to the ISD. A primary dummy load 663 may be connected with an ON/OFF switch 665, which is controlled by controller 668 through a voltage signal 667 generated by the controller. The block 670 is an SMPS type AC to DC multi/single output standby power supply to provide power to the controller 668 and in the event of failure of the converters 660 and/or 662 to provide power to the aspect 4. A partial/complete failure of aspect 4 and/or failure of controller 660 is detected by the decrease in the DC aspect current. Decrease in DC current is observed by the controller 668 through feedback 678, and as per desired settings, the controller makes changes in the supply line current to allow the distantly placed alarming system to sense the change in supply line current and initiate alarms. Selection of Blanking and Non-blanking option is through a jumper 674. In the event of partial aspect failure, in blanking mode aspect will go blank whereas in non-blanking mode, aspect will continue to be lit-up.

The supply line current is regulated along with the power factor correction for enabling communication of a failure message on the supply line without requiring additional or separate line for communication failure message. The failure message is communicated by significantly changing current flowing through the supply line 1, which in normal operational condition, is expected to be substantially constant by dynamically altering the DC voltage 661 progressively from normal to zero by 668, using feedback 669 and/or switching OFF the dummy load 663. Maintaining constant current and near unity power factor during a normal operation ensures a fool-proof and safe signaling system, without being affected by the inductance and other parameters of the Electric Current Relay (ECR). A near unity power factor not only saves energy but enhances the performance of the generation equipment.

FIG. 4 shows detailed block diagram of the alarming system (6 of FIG. 1), which includes sensor 10 connected to a diode bridge 22 for providing a polarity independent DC voltage, based on the current through the sensor. The alarming system may also consist of

a. its inbuilt power supply 103 consisting of parallel redundant SMPS units with visual indications and a circuitry 102 to sense and indicate failures of SMPS units,

b. a circuitry 104 to sense and indicate failure of current regulator 2 and aspect 4, as per FIG. 1,

c. a circuitry 101 to sense and indicate failure of alarming system.

d. Its own power supply 53.

The current flowing through supply line 1 induces an AC voltage in coil 10. This voltage is fed to a diode bridge 22. The DC output voltage of diode bridge 22 is fed to comparators 24 and 26 which could be discrete circuitry or micro controller based for comparing said DC voltage with a reference voltage. In case the said DC voltage drops below the reference voltage, the comparator 24, 26 will operate the visual 28, 30 and audio 32, 64 alarms respectively, to indicate that the aspect (4, of FIG. 1) and/or current regulator (2, of FIG. 1) needs attention. Information to a Central Computer through data logger may also be provided as an alarm. The alarming system 6 may be connected to another distantly located alarming system 8 through potential free contacts and powered by its own supply.

In case the output of the comparator, 24 and 26 are not the same, the comparators 36 and 38 become active and operate alarms 32, 64, 40, 42 respectively. Information may also be given to the computer. This indicates that the alarming system 6 itself is not functioning correctly. The alarming system has its own power supply 103 duly protected from disturbances. All the components of the power supply 103 of the alarming unit are powered by regulated power supply 53. The power supply 103 also incorporates SMPSs in parallel redundant mode and a self test circuitry 102 as in the case of current regulator with circuitry for self test as described above to detect failure of current regulator and aspect.

The self test operation of the power supply can be understood as follows. The power supply 103 has mains ON indicators 47 and 51 and a diode bridge 49 connected to two sets of redundant SMPS based power supplies 48, 50, 52 and 54 such that failure of even any three of the four supplies will not affect the unit. Failure of one supply will be detected by comparators 55,57,59,61, which will cause power supply failure indications 56, 58 to light on the aspect cards and indications 60, 62 to light up on the power supply cards and give a power supply failure indication to the control circuits 31,63 of the distantly located alarming unit, which in turn will light up two parallel audio alarms 32, 64. The distantly located alarm system 105 consists of two audio alarms consisting of two parallel buzzers 32 and 64 which will be set off whenever any failure indication comes from 104, 101 or 102. The block 105 is powered by its own power supply (not shown). Further each buzzer is connected with a two pole toggle switch 66, 68 such that switching off the buzzer will light a red LED 70, 72 to indicate that the buzzer has been manually switched off. A number of printed circuit cards (aspect cards) may be required to monitor various current controllers and aspects and they may all be powered by one power supply card.

All comparator outputs are sensed by a controller 74) which may or may not be separate from main controller, which communicates the status through a data logger 76 and modem 78 to a central computer 80 to pinpoint the time of occurrence of any defect or its rectification.

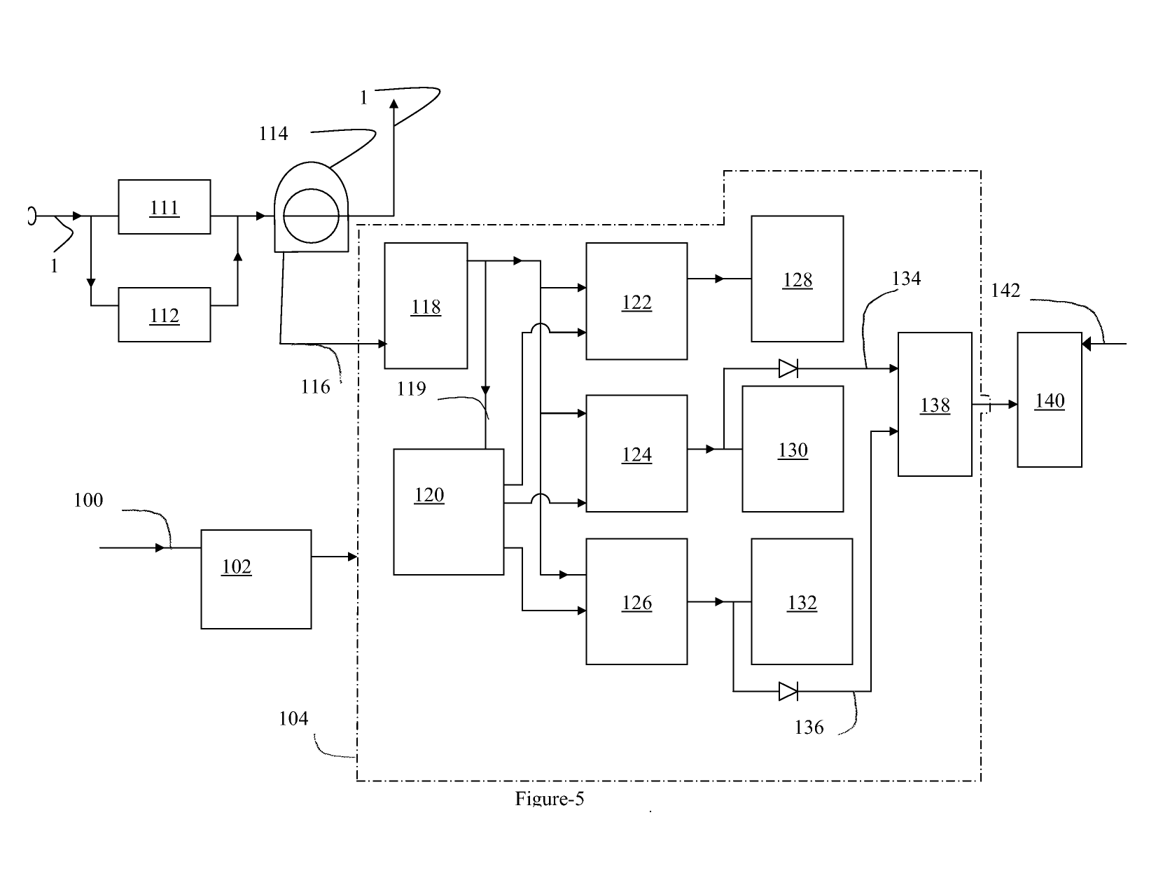

FIG. 5 shows another embodiment of the alarming system. The alarming system is placed between the ECR (not shown) and the current regulator (2, of FIG. 1). The electric current flowing through the supply line 1 is limited by a fuse, 111. An indicator, 112 shows the condition of the fuse. The said current flows through the current transformer, 114 through the supply line 1 to the distantly located current regulator and aspect as per FIG. 1. An AC voltage proportional to the said current is induced in 116 which is then converted into a D.C. voltage and filtered by circuit 118. Regulated D.C. voltage is supplied to the entire electronics 104 by a suitable power supply circuit, 102 for which the input supply is 100. Circuit 120 generates a stable different reference voltage level when it receives a signal 119 that circuit 118 is operational. The out put of 118 is compared with their respective reference voltage generated by 120 by the comparators and detectors, 122, 124, 126 to indicate through:

Circuit 128 that current regulator (6, of FIG. 1) and aspect (4, of FIG. 1) are O.K.

Circuit 130 that aspect (4, of FIG. 1) is dimly lit.

Circuit 132 that current regulator (6, of FIG. 1) and/or Aspect (4, of FIG. 1) are Fail.

The output of circuit 124 and 126 through two input OR-Gate circuits made by two diodes 134 and 136 respectively, with or without potential free contacts 138 are connected to a distantly located alarming unit 140 for an audio visual alarm as provided in 105 of FIG. 4. Supply to the alarming unit is 142.

The invention herein described with reference to an illustrative example only, and the scope of the invention is not limited to the described embodiment only. A person skilled in the art will appreciate that many other embodiments of the present invention without deviating from the basic concept of the invention are possible. Any such work, around the concept of the invention, will fall within the scope of the invention.

We claim:

1. A signaling system comprising, a power supply line coupled to an aspect through a current regulator, said aspect having a plurality of light sources, said current regulator, is configured for maintaining substantially unity power factor and for maintaining substantially constant current level through the supply line during normal operation of the system, said regulator is further configured for detecting a complete/partial failure of the aspect and communicating an indication indicative of the failure over the supply line by significantly varying current level through the supply line as against the substantially constant current level which is maintained during normal operation of the system.

2. The signaling system as claimed in claim 1 wherein said system further comprises an alarming system configured to sense failure of the aspect and/or the current regulator by sensing changes in the current flowing through the supply line and initiating alarm on receipt of an indication indicative of the failure.

3. The signaling system as claimed in claim 1 wherein said significant variation in current level is of the order of 20% to 80%, as against the constant current level.

4. The signaling system as claimed in claim 1 wherein said regulator further comprises a noise sensing circuit for sensing and rejecting noise voltage induced in the supply line.

5. The signaling system as claimed in claim 1 wherein said regulator includes a plurality of switch mode power supplies (SMPS) and/or one or more dummy load/s.

6. The signaling system as claimed in claim 5 wherein said regulator further comprises a controller for controlling the current through the supply line by switching on/off the SMPS or the dummy load/s or any combination thereof and for maintaining a power factor substantially unity.

7. The signaling system as claimed in claim 5 wherein said dummy loads are SMPS and/or resistors and/or capacitors and/or inductors or any combination thereof.

8. The signaling system as claimed in claim 1 wherein said regulator comprises a DC to DC converter for supplying a controlled voltage to the aspect.

9. The signaling system as claimed in claim 1 wherein said regulator comprises an AC to DC converter providing its output to a DC to DC converter.

10. The signaling system as claimed in claim 1 wherein said regulator is provided with redundant SMPS for ensuring a uninterrupted functioning of the system in case of failure of one or more SMPS.

11. The signaling system as claimed in claim 2 wherein said alarming system further comprises a data logger for registering functional status of components of the alarming system and the functional status of the signaling system.

12. The signaling system as claimed in claim 1 wherein said system comprises an Electric Current Relay (ECR) connected to the current regulator to sense the failure and accordingly setoff alarm/s.
